(19) United States
(12) Patent Application Publication
(10) Pub. No.: US 2014/0350891 A1
(43) Pub. Date: Nov. 27, 2014

(54) INTERFACE FOR TRANSFERRING TIME-SAMPLED SENSOR DATA

(71) Applicant: Apple Inc., Cupertino, CA (US)

(72) Inventors: Robert D. Zupke, Santa Clara, CA (US); Tony Chi Wang Ng, Santa Clara, CA (US); Jahan C. Minoo, San Jose, CA (US)

(73) Assignee: Apple Inc., Cupertino, CA (US)

(21) Appl. No.: 13/902,330

(22) Filed: May 24, 2013

(51) Int. Cl. H04L 13/16

(52) U.S. Cl. CPC H04L 13/16
USPC 702/189

(57) ABSTRACT

The disclosed embodiments relate to a system for transmitting data from a sensor to a host. During operation, the system periodically samples data at the sensor with reference to a sensor clock. Next, the system uses the sensor clock to transmit the data from the sensor to the host, wherein the host operates with reference to a host clock, which is different than the sensor clock. During the transmission process, the system embeds a clock in the data, wherein the embedded clock can be extracted at the host and used to receive the transmitted data. In some embodiments, transmitting the data involves using voltage-mode signaling. In other embodiments, transmitting the data involves using current-mode signaling.

### RELATED ART

The disclosed embodiments generally relate to techniques for communicating data between electronic devices. More specifically, the disclosed embodiments relate to techniques for transferring time-sampled sensor data from a sensor device to a host system.

### BACKGROUND

As mobile computing devices (such as smartphones) become increasingly more sophisticated, they are beginning to incorporate a variety of sensors for gathering different types of data, such as accelerometer data, gyroscope data, ambient-light sensor data, GPS data, and even barometer data. However, existing techniques for transferring data from sensors to associated processing circuitry are not well-suited for portable computing devices because they use extra wires, consume unnecessary power, and have problems synchronizing timing between a jittery sensor clock and a more stable application-processor clock.

Hence, what is needed is a technique for transferring sensor data to associated processing circuitry without the above-described problems.

### SUMMARY

The disclosed embodiments relate to a system for transmitting data from a sensor to a host. During operation, the system periodically samples data at the sensor with reference to a sensor clock. Next, the system uses the sensor clock to transmit the data from the sensor to the host, wherein the host operates with reference to a host clock, which is different than the sensor clock. During this transmission process, the system embeds a clock in the data, wherein the embedded clock can be extracted at the host and used to receive the transmitted data.

In some embodiments, transmitting the data involves using voltage-mode signaling to transmit the data.

In some embodiments, the voltage-mode signaling involves using an interface with three lines, including a power line, a ground line, and a data-carrying line.

In some embodiments, transmitting the data involves using current-mode signaling to transmit the data.

In some embodiments, the current-mode signaling involves using an interface with two lines, including a ground line and a data-carrying line, which also serves as a power line.

In some embodiments, the sensor receives power from the host through a power line that is part of an interface between the sensor and the host.

In some embodiments, transmitting the data involves scrambling the data prior to transmission to ensure that a frequency spectrum of the transmitted signals is evenly distributed across a range of frequencies. In some embodiments, this scrambling is accomplished by using a Linear Feedback Shift Register (LFSR).

In some embodiments, transmitting the data involves transmitting three channels of sensor data using a frame format that supports two channels of data.

### BRIEF DESCRIPTION OF THE FIGURES

FIG. 1 illustrates a sensor device connected to a host in accordance with the disclosed embodiments.

FIG. 2A illustrates an embodiment that supports voltage-mode signaling.

FIG. 2B illustrates another embodiment that supports voltage-mode signaling.

FIG. 3A illustrates an embodiment that supports current-mode signaling.

FIG. 3B illustrates another embodiment that supports current-mode signaling.

FIG. 3C illustrates yet another embodiment that supports current-mode signaling.

FIG. 4A illustrates encoded bus states for bit strings “000” and “111” in accordance with the disclosed embodiments.

FIG. 4B illustrates an exemplary frame format in accordance with the disclosed embodiments.

FIG. 5 illustrates a linear-feedback shift register (LFSR) scrambler circuit in accordance with the disclosed embodiments.

FIG. 6 presents a flow chart illustrating the process of communicating sensor data from the sensor device to the host in accordance with the disclosed embodiments.

FIG. 7 illustrates how sensor samples are processed prior to being transmitted to the host in accordance with the disclosed embodiments.

Table 1 illustrates various preamble definitions in accordance with the disclosed embodiments.

### DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the disclosed embodiments. Thus, the disclosed embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored on a non-transitory computer-readable storage medium as described above. When a system reads and executes the code and/or data stored on the non-transitory computer-readable storage medium, the system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

The disclosed embodiments provide an interface to support unidirectional digital data transfer with an embedded clock between a sensor device, such as an accelerometer, and a host device, such as a smartphone. In typical applications, the interface uses a length of wire to connect the sensor and the host, wherein the sensor and the host do not reside on the same PCB. Moreover, power nets on the sensor device PCB are derived from corresponding power nets on the host device PCB. This interface was designed with a number of goals in mind, including: (1) synchronizing clock domains between the sensor and the host; (2) low wire count between the sensor and the host; (3) ensuring that the frequency spectrum of the transmitted signals is evenly distributed across a range of frequencies; (4) transferring power for the host to the sensor; and (5) low power consumption. Various embodiments of the interface are described in more detail below.

### Exemplary Sensor Device

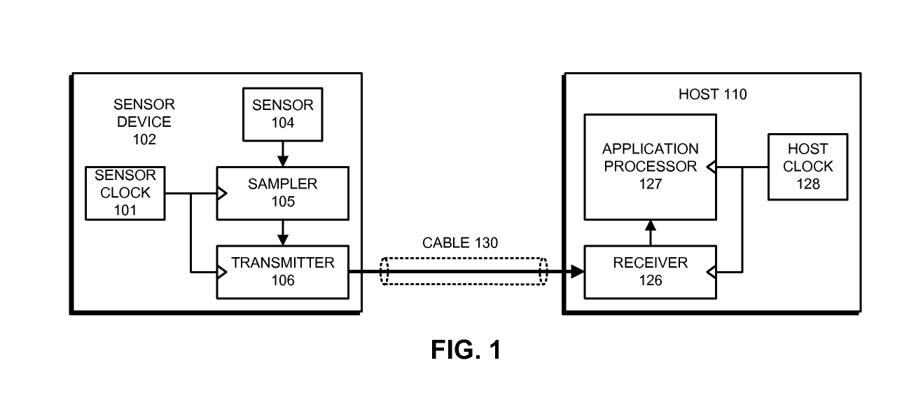

FIG. 1 illustrates how an interface can be used to connect a sensor device 102 to a host 110 in accordance with the disclosed embodiments. Sensor device 102 can generally include any type of sensor which can be periodically sampled to gather data, including but not limited to: (1) an accelerometer, (2) a gyroscope, (3) an ambient-light sensor data, (4) a global-positioning system (GPS) transceiver, (5) a barometer, (6) a radiation sensor, (7) an electromagnetic field (EMF) sensor, (8) a temperature sensor, (9) a pressure sensor, (10) an audio sensor, (11) a magnetic field sensor, and (12) a vibration sensor. Host 110 can generally include any type of computing device that can process the sensor data, including but not limited to: (1) a smartphone, (2) a tablet computer, (3) a laptop computer, (4) a desktop computer, and (5) a server computer.

Within sensor device 102, a sensor 104, such as an accelerometer, outputs a signal that is periodically sampled by a sampler circuit 105 to produce a stream of data values, which is sent to a transmitter 106. Transmitter 106 communicates this stream of data values through a cable 130 to a receiver 126 in host 110, wherein cable 130 includes two or more lines as is described in more detail below. Sampler 105 and transmitter 106 operate with reference to a sensor clock 101, which is generated locally by circuitry within sensor device 102.

Within host 110, receiver 126 can perform various synchronization and sample-rate-conversion operations on the stream of data, and then communicates the stream of data values to an application processor 127, which can process the stream of data values. Receiver 126 and application processor 127 operate with reference to a host clock 128, which is generated locally by circuitry within host 110.

In some embodiments, transmitter 106 and receiver 126 are configurable to provide either voltage-mode signaling or current-mode signaling as is described in more detail below.

### Voltage-Mode Signaling

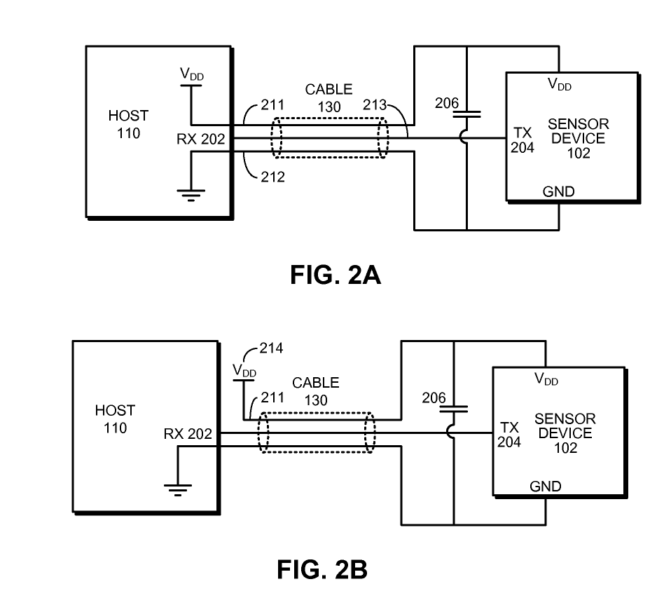

To support voltage-mode signaling, transmitter 106 can function as a single-ended voltage-signaled interface with push-pull drivers. More specifically, FIG. 2A illustrates an embodiment that supports voltage-mode signaling in accordance with the disclosed embodiments. In this embodiment, the interface includes a cable 130 which provides three lines, including a power line 211, a ground line 212 and a signal line 213 which connects the transmit output (TX) 204 of sensor device 102 with the receive input (RX) 202 of host 110. Note that host 110 supplies power to sensor device 102 through power line 211 and ground line 212 in cable 130. Moreover, a bypass capacitor 206 can be placed between the V_{DD} and Ground pins of sensor device 102.

In some embodiments, because of the unidirectional architecture of the interface, host 110 uses the power path to sensor device 102 to change the state of the device. In these embodiments, sensor device 102 can be enabled or disabled by simply applying or removing power.

FIG. 2B illustrates an alternative embodiment that supports voltage-mode signaling in accordance with the disclosed embodiments. This embodiment is essentially the same as the embodiment illustrated in FIG. 2A, except that power line 211 does not connect to an internal V_{DD} in a power net within host 110, but instead connects to another V_{DD} 214, which is external to host 110.

### Current-Mode Signaling

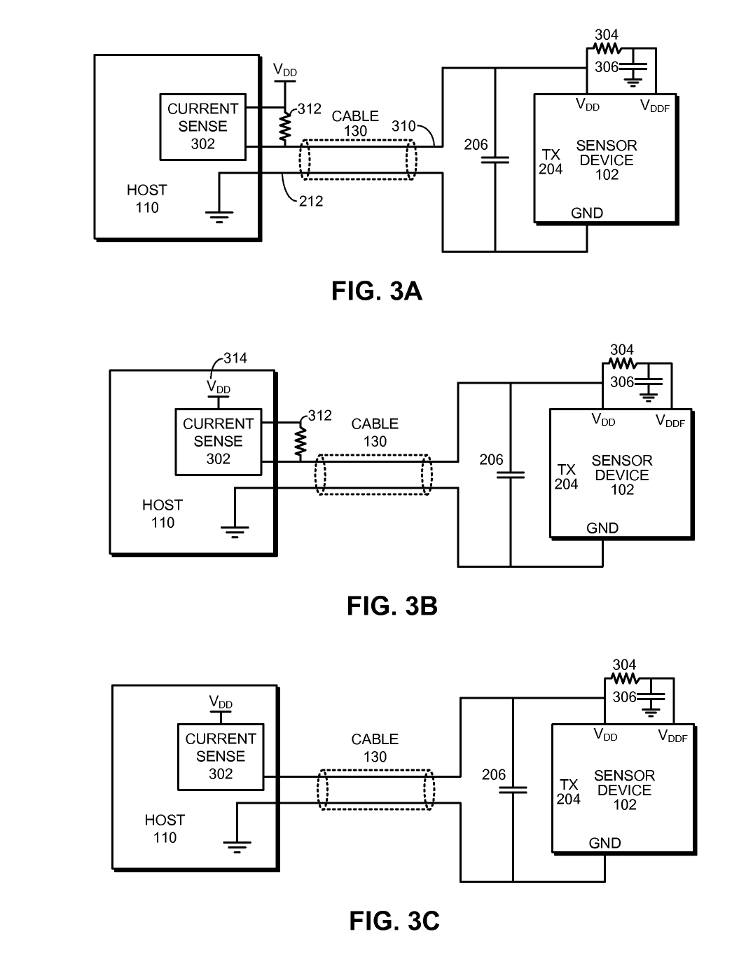

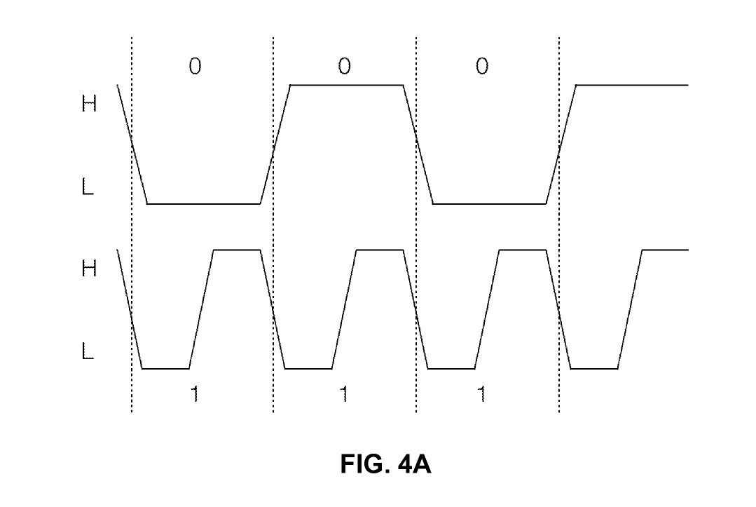

FIG. 3A illustrates an embodiment that supports current-mode signaling in accordance with the disclosed embodiments. As illustrated in FIG. 3A, host 110 provides only two lines 212 and 310. The first of these lines 212 is ground. The second of these lines 310 is a data-carrying line that also serves as a power line, which supplies power from host 110 to the sensor device 102. Note that the data and the embedded clock are transmitted from sensor device 102 to host 110 through changes in the current that is drawn by sensor device 102 through line 310 as described more detail below. During this process, a receiver 126 within the host 110 processes a data-carrying current component, which lies on top of the DC current component that is used to power sensor device 102.

In FIG. 3A, host 110 makes use of an external sense resistor 312 (which is tied to V_{DD}) to convert the current signal into a voltage signal, which is measured by current-sense circuitry 302 within host 110. An alternative embodiment (which is illustrated in FIG. 3B) powers sense resistor 312 using a power source V_{DD} 314 that is obtained from an internal power net within host 110. Using an internal V_{DD} 314 is advantageous, because the internal V_{DD} 314 can be filtered to remove noise.

Yet another embodiment is illustrated in FIG. 3C. In this embodiment, there is no sense resistor. Instead, current-sense circuitry 302 within host 110 includes an internal sense element, which can be implemented using transistors and/or current mirrors, and which can be more precise than using a sense resistor. Moreover, this embodiment eliminates the direct current resistance (DCR) that a sense resistor inserts into the power path. Hence, this embodiment can potentially consume a lot less power.

Another optimization that appears in the top right-hand corner of FIGS. 3A, 3B and 3C is a power-filtering circuit implemented as a low-pass filter, which comprises a resistor 304 and a capacitor 306. This low-pass filter produces a clean power signal that feeds into a V_{DD} filter pin (V_{DDF}) of sensor device 102. This low-pass filter allows sensor device 102 to use a noisy power source that is modulating while sending data. Note that sensor device 102 provides two pins for power (V_{DD} and V_{DDF}) instead of a single pin. Also note that the V_{DD} pin is directly connected to the integrated current sink, while the other pin V_{DDF} provides a filtered power connection to deliver power to the rest of sensor device 102.

### Encoding

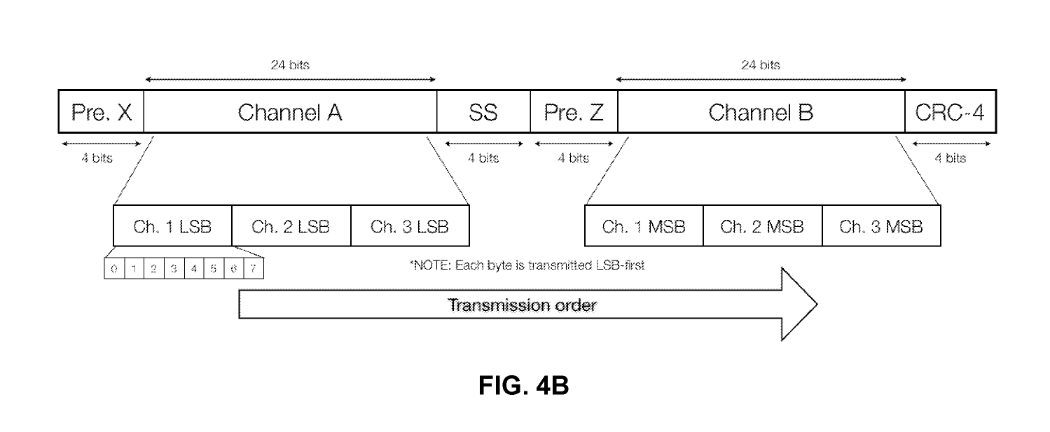

Some of the disclosed embodiments use biphase mark code (BMC) to encode the data on the bus. In this encoding, each time slot (encoded-bit period) is guaranteed to have one transition (H to L or L to H), which occurs at the start of the time slot. A ‘0’ is encoded as having only one transition in one time slot, while a ‘1’ is encoded as having two transitions. The extra transition that an encoded ‘1’ uses occurs at the midpoint of the time slot. Thus, if a single time slot is represented by two unit interval bus states (H or L), the bit string “000” can be encoded as “LLHHLL”. Similarly, the bit string “111” can be encoded as “LHLHLH”. FIG. 4A illustrates these sequences of bus states.

TABLE 1

| Preamble | Previous Bus State = H | Previous Bus State = L |
|---|---|---|
| X | LLLHHHLH | HHHLLLHL |
| Z | LLLHLHHH | HHHLHLL |

One exception to the rule outlined above regarding the guarantee of one transition per time slot is the use of preambles. In some embodiments, there are two preambles, denoted X and Z. Each of these preambles is four time slots in length and employs two violations of BMC (two time slots are started with no transition) so that the receiver may easily acquire a lock on the bit stream. Because these are violations of BMC, they cannot be represented as a bit string, but can instead be represented by the bus state per unit interval. (See Table 1 above, which defines these preambles.)

### Frame Format

FIG. 4B illustrates an exemplary frame format in accordance with the disclosed embodiments. This exemplary frame format is designed to accommodate two channels of 24-bit audio data. As is described below, we can adapt this 24-bit frame to accommodate three channels of 16-bit sensor. Moreover, we can use similar techniques to accommodate different numbers of sensor channels with different sample sizes. For example, we can possibly accommodate four channels of 12-bit sensor data, six channels of 8-bit sensor data, or two channels of 24-bit sensor data.

The exemplary frame format illustrated in FIG. 4B is a variant of a frame format that is specified in the audio engineering society 3 (AES3) standard. Note that a single frame is comprised of two channels, A and B, each of which has 4 time slots dedicated to a preamble, 24 time slots dedicated to data, and 4 time slots dedicated to control codes. Frames are transmitted at the same rate as the sensor sampling frequency, one after another with no delay or idle time between them. Moreover, channel A is preceded by preamble X, and channel B is preceded by preamble Z. Also, the final 4 time slots of each channel represent a 4-bit control sequence. This control sequence SS (which occurs at the end of channel A) represents the scrambler status, which is described in more detail below.

The control sequence at the end of channel B is a 4-bit cyclic redundancy check (CRC), which is calculated based on the unscrambled 48-bits of data contained in the combined channels in a frame. This CRC is appended directly after the 24 bits of data in Channel B. The following generating polynomial can be used to calculate this CRC:

Q(x)=x⁴+1

Note that CRCs are calculated LSB-first and transmitted LSB-first, due to the LSB-first nature of the interface.

The AES3 standard provides for sending 24-bits of data on a single channel, and the disclosed embodiments adapt this 24-bit frame to allow for three channels of 16-bit data to be repackaged into two channels of 24-bit data. The least significant bytes (LSBs) from each of the three 16-bit channels are concatenated to form the 24-bit data payload of Channel A. Similarly, the most significant bytes (MSBs) from each of the three 16-bit channels are concatenated to form the 24-bit data payload of Channel B. The orientation of the samples is least significant bit first.

If the device produces N-bit samples that are less than 16 bits in length, the samples are zero-padded from the LSB to produce 16-bit samples, wherein the N-bit sample occupies the N-most significant bits of the 16-bit output sample.

### Scrambler Circuitry

During operation, it is possible for the data pattern to cause the frequency content on the interface to be clustered around a specific frequency (i.e., a stream of zeros from the device). Therefore, the data is scrambled prior to BMC encoding to ensure that the frequency content on the interface remains evenly distributed.

As specified in the IEEE 1394b-2002 standard, the system can employ a side stream scrambler that uses the following generating polynomial:

G(x)=x¹¹+x⁹+1.

This generating polynomial defines a linear feedback shift register (LFSR) that operates at the bit clock rate of the interface and continuously generates the kth value of the scrambler shift register. The scrambler shift register also operates at the bit clock rate of the interface and has an output value defined by Scr(k:k+7). Based on the generating polynomial, the output of the LFSR and input to the scrambler shift register can be defined as follows:

Scr(k)=Scr(k−9)XOR Scr(k−11).

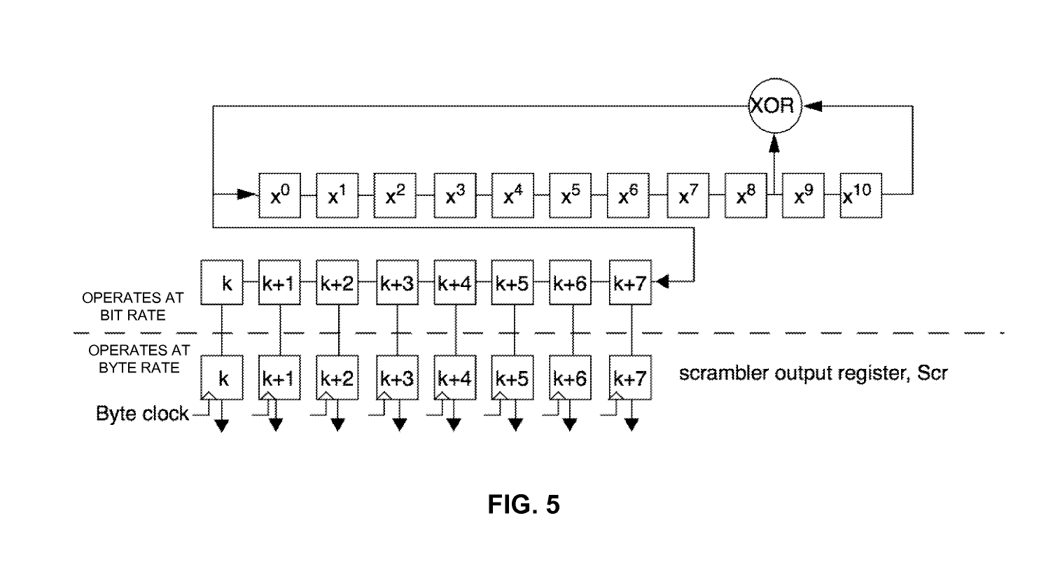

FIG. 5 illustrates exemplary LFSR scrambler circuitry in accordance with the disclosed embodiments. Note that each byte to be scrambled is XORed with the output of the scrambler register. More specifically, the MSB of the byte to be scrambled is XORed with Scr(k) while the LSB is XORed with Scr(k+7).

This scrambling occurs before both the framing and BMC encoding is done on the sensor device side of the interface. Note that the bytes of data to be placed in a frame are first passed through the side-stream scrambler in the order that they will be transmitted.

Even though preambles and the SS and CRC sequences are not scrambled, the clock of the portion of the scrambler that operates at the bit clock rate of the interface is still running during the times preambles and the SS/CRC are being transmitted.

The 4-bit SS control sequence, which is transmitted after Channel A's 24 data bits are transmitted, is used to send a snapshot of a portion of the device's scrambler to the host so that the host can reconstruct the state of the scrambler. The four bits to send are defined as follows:

SS[3:0]={Scr[k],Scr[k+2],Scr[k+4],Scr[k+6]}.

As with the data and the CRC, the SS sequence is sent LSB-first.

### Process of Communicating Sensor Data

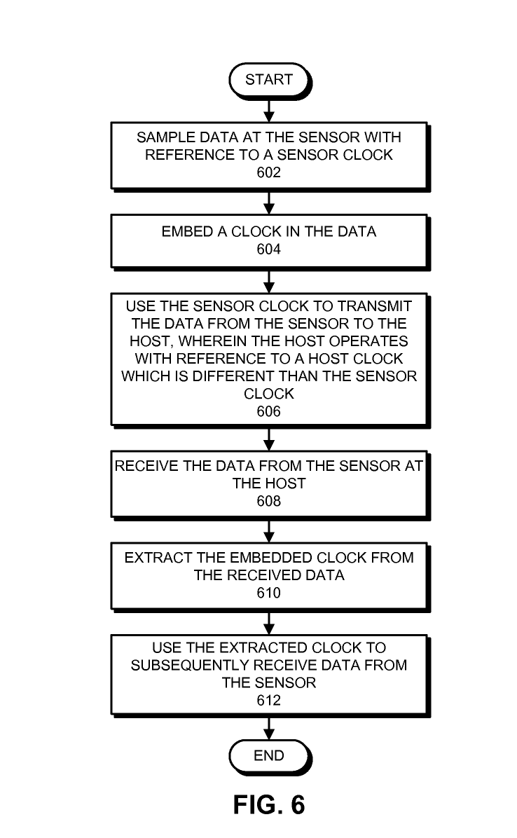

FIG. 6 presents a flow chart illustrating the process of communicating sensor data from the sensor device 102 to the host 110 in accordance with the disclosed embodiments. During operation, the system periodically samples data at the sensor with reference to a sensor clock (step 602). Next, the system embeds a clock in the data using the preambles X and Z as is described above (step 604). Next, the system uses the sensor clock to transmit the data from the sensor to the host, wherein the host operates with reference to a host clock, which is different than the sensor clock (step 606).

Then, the system receives data from the sensor at a host (step 608), and extracts the embedded clock from the received data (step 610). The system subsequently uses the extracted clock to receive data from the sensor (step 612).

### Processing Sensor Samples Prior to Transmission

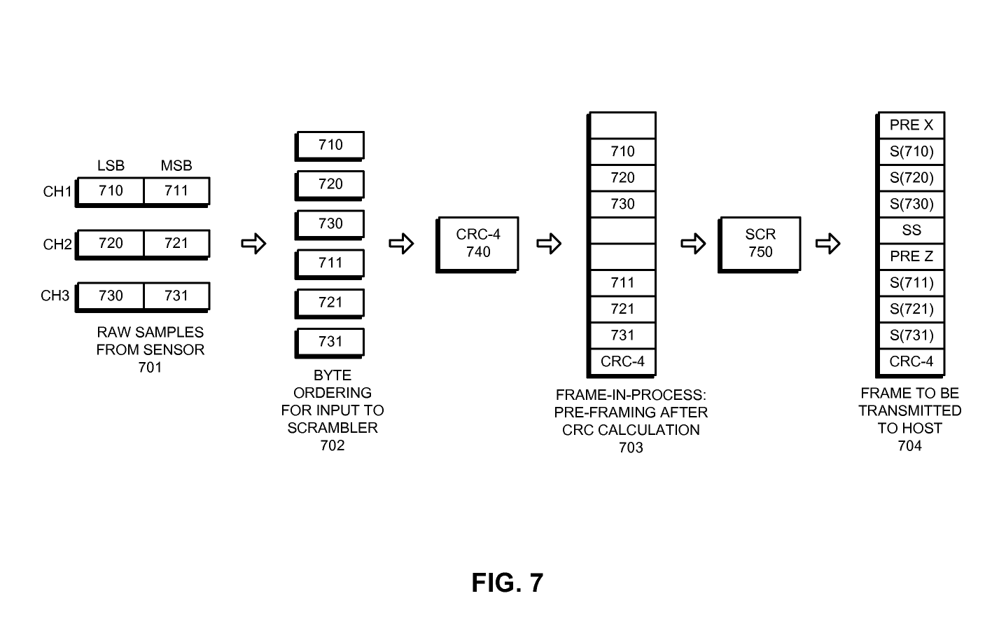

FIG. 7 illustrates how sensor samples are processed prior to being transmitted to the host in accordance with the disclosed embodiments. At the start of this process, the system receives raw samples from the sensor 701. For example, if the sensor is an accelerometer, the system can receive three 16-bit samples (on channels 1, 2 and 3) representing acceleration components in the X, Y and Z directions. As illustrated in FIG. 7, each of the three samples is divided into an MSB and an LSB. More specifically, the sample on channel 1 is divided into an MSB 711 and an LSB 710, the sample on channel 2 is divided into an MSB 721 and an LSB 720, and the sample on channel 3 is divided into an MSB 731 and an LSB 730.

Next, the system reorders these bytes to produce a byte ordering 702 for input to the scrambler (710, 720, 730, 711, 721 and 731). The system then performs a CRC computation 740 and performs a pre-framing operation to generate a frame-in-process 703. Finally, the system performs a scrambling operation 750 on data values in this frame-in-process (using an LFSR), and also generates the preambles X and Z to produce a frame-to-be-transmitted 704 prior to encoding for transmission.

When the transmitted frame is ultimately received at the host, the process illustrated in FIG. 7 is performed in reverse to restore the three 16-bit samples of sensor data.

The foregoing descriptions of disclosed embodiments have been presented only for purposes of illustration and description. They are not intended to be exhaustive or to limit the disclosed embodiments to the forms disclosed. Accordingly, many modifications and variations will be apparent to practitioners skilled in the art. Additionally, the above disclosure is not intended to limit the disclosed embodiments. The scope of the disclosed embodiments is defined by the appended claims.

What is claimed is:

1. A method for transmitting data from a sensor to a host, comprising:
periodically sampling data at the sensor, wherein the data is sampled with reference to a sensor clock; and
using the sensor clock to transmit the data from the sensor to the host;
wherein the host operates with reference to a host clock which is different than the sensor clock; and
wherein transmitting the data includes embedding a clock in the data, wherein the embedded clock can be extracted at the host and used to receive the transmitted data.

2. The method of claim 1, wherein transmitting the data involves using voltage-mode signaling to transmit the data.

3. The method of claim 2, wherein transmitting the data using voltage-mode signaling involves using an interface with three lines, including:
a power line;
a ground line; and
a data-carrying line.

4. The method of claim 1, wherein transmitting the data involves using current-mode signaling to transmit the data.

5. The method of claim 4, wherein transmitting the data using current-mode signaling involves using an interface with two lines, including:
a ground line; and
a data-carrying line which also serves as a power line.

6. The method of claim 1, further comprising receiving power for the sensor from the host through a power line that is part of an interface between the sensor and the host.

7. The method of claim 1, wherein transmitting the data involves scrambling the data prior to transmission to ensure that a frequency spectrum of the transmitted signals is evenly distributed across a range of frequencies.

8. The method of claim 1, wherein scrambling the data involves using a Linear Feedback Shift Register (LFSR).

9. The method of claim 1, wherein transmitting the data involves transmitting three channels of sensor data using a frame format that supports two channels of data.

10. A method for receiving data from a sensor, comprising:
receiving data from the sensor at a host, wherein the data was sampled and sent from the sensor with reference to a sensor clock, and wherein the host operates with reference to a host clock which is different than the sensor clock;
extracting an embedded clock from the received data; and
using the extracted clock to subsequently receive data from the sensor.

11. The method of claim 10, wherein receiving the data involves using voltage-mode signaling to receive the data.

12. The method of claim 10, wherein receiving the data involves using current-mode signaling to receive the data.

13. The method of claim 10, further comprising sending power to the sensor from the host through a power line that is part of an interface between the sensor and the host.

14. The method of claim 10, wherein receiving the data involves unscrambling the data, wherein the data was scrambled at the sensor prior to transmission to ensure that a frequency spectrum of the transmitted signals is evenly distributed across a range of frequencies.

15. The method of claim 10, wherein receiving the data involves receiving three channels of sensor data through a frame format that supports two channels of data.

16. An apparatus that transmits sensor data to a host, comprising:
a sensor;
a sampler configured to periodically sample data from the sensor with reference to a sensor clock;
a transmitter configured to transmit the data from the sensor to the host using the sensor clock, wherein the host operates with reference to a host clock which is different than the sensor clock; and
wherein the transmitter is configured to include an embedded clock in the transmitted data, wherein the embedded clock can be extracted by the host and used to receive the transmitted data at the host.

17. The apparatus of claim 16, wherein the transmitter is configured to use voltage-mode signaling to transmit the data.

18. The apparatus of claim 17, wherein the transmitter is configured to use an interface with three lines to perform the voltage-mode signaling, including:
a power line;
a ground line; and
a data-carrying line.

19. The apparatus of claim 16, wherein the transmitter is configured to use current-mode signaling to transmit the data.

20. The apparatus of claim 19, wherein the transmitter is configured to use an interface with two lines to perform the current mode-signaling, including:
a ground line; and
a data-carrying line which also serves as a power line.

21. The apparatus of claim 16, wherein the apparatus is configured to receive power from the host through a power line that is part of an interface between the sensor and the host.

22. The apparatus of claim 16, wherein prior to transmitting the data, the transmitter is configured to scramble the data to ensure that a frequency spectrum of the transmitted signals is evenly distributed across a range of frequencies.

23. The apparatus of claim 16, wherein the transmitter is configured to use a Linear Feedback Shift Register (LFSR) to scramble the data.

24. The apparatus of claim 16, wherein while transmitting the data, the transmitter is configured to transmit three channels of sensor data using a frame format that supports two channels of data.

25. An apparatus for receiving data from a sensor, comprising:
a receiver located at a host which is configured to receive data from a sensor, wherein the data was sampled and sent from the sensor with reference to a sensor clock, and wherein the receiver operates with reference to a host clock which is different than the sensor clock;
wherein the receiver is configured to extract an embedded clock from the received data; and
wherein the receiver is configured to use the extracted clock to subsequently receive data from the sensor.

26. The apparatus of claim 25, wherein the receiver is configured to use voltage-mode signaling to receive the data.

27. The apparatus of claim 25, wherein the receiver is configured to use current-mode signaling to receive the data.

28. The apparatus of claim 25, wherein the receiver is configured to send power to the sensor through a power line that is part of an interface between the sensor and the host.

29. The apparatus of claim 25, wherein the receiver is configured to unscramble the received data, wherein the data was scrambled at the sensor prior to transmission to ensure that a frequency spectrum of the transmitted signals is evenly distributed across a range of frequencies.

30. The apparatus of claim 25, wherein the receiver is configured to receive three channels of sensor data through a frame format that supports two channels of data.
